(19) United States
(12) Patent Application Publication
(10) Pub. No.: US 2014/0207333 A1
(43) Pub. Date: Jul. 24, 2014

(54) VEHICLE SEAT MASSAGE SYSTEM AND METHOD

(71) Applicant: FORD GLOBAL TECHNOLOGIES, LLC, Dearborn, MI (US)

(72) Inventors: Karl Douglas Vandivier, Belleville, MI (US); Jeroen Lem, Maastricht (NL); Yifan Chen, Ann Arbor, MI (US); Basavaraj Tonshal, Northville, MI (US); Steve Michell, Commerce, MI (US); Milind Modi, Canton, MI (US)

(73) Assignee: FORD GLOBAL TECHNOLOGIES, LLC, Dearborn, MI (US)

(21) Appl. No.: 13/749,283

(22) Filed: Jan. 24, 2013

(51) Int. Cl. B60N 2/44

(52) U.S. Cl. CPC B60N 2/448
USPC 701/36

(57) ABSTRACT

A seat massage system for a vehicle includes a vehicle seating assembly that has a massaging apparatus. The seat massage system also includes a positioning device for determining a location of the vehicle. A controller controls the massaging apparatus based on the determined location of the vehicle or a location characteristic of the vehicle.

### FIELD OF THE INVENTION

The present invention generally relates to a massage system for a vehicle seating assembly, and more particularly to a method and system for controlling a vehicle seat massaging apparatus based on a vehicle location or location characteristic.

### BACKGROUND OF THE INVENTION

Seating assemblies for vehicles are progressively developing to be more adapted for occupant comfort in a variety of environments and for a number of driver and passenger preferences. With this, the number of occupant comfort features that frequently require user interaction and actuation have similarly increased. Occasionally, modern vehicle seating assemblies are equipped with massaging capabilities that have a variety of massage settings and types. Accordingly, methods and systems to accommodate the different occupant comfort features and desired settings for drivers and passengers, as well as the desired massage settings and types, has become increasingly more important.

### SUMMARY OF THE INVENTION

According to one aspect of the present invention, a seat massage system for a vehicle includes a vehicle seating assembly that has a massaging apparatus. A positioning device determines a location of the vehicle. A controller controls the massaging apparatus based on the determined location of the vehicle.

According to another aspect of the present invention, a seat massage system for a vehicle includes a seat massager in the vehicle. The seat massaging system also includes a sensor for sensing a location characteristic of the vehicle. A controller automatically actuates the seat massager based on the sensed location characteristic.

According to yet another aspect of the present invention, a method for controlling a vehicle seat massager includes providing a seat massager in a vehicle. A location of the vehicle is determined with a positioning device. The seat massager is controlled based on the determined location of the vehicle.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a top perspective view of an interior of a vehicle, showing a driver side seating assembly, a passenger side seating assembly, and a center console having a display screen;

FIG. 2 is a top perspective view a vehicle seating assembly having a massaging apparatus;

FIG. 3 is a schematic block diagram of the seat massage system;

FIG. 4 is a perspective view showing the vehicle on a map;

FIG. 5 is a flow chart illustrating a method for controlling the vehicle seat massager;

FIG. 6 is a front view of a user interface showing a menu of settings for the vehicle seat massager;

FIG. 7A is a front view of the user interface showing one embodiment of massage preferences for the vehicle seat massager; and

FIG. 7B is a front view of the user interface showing another embodiment of massage preferences for the vehicle seat massager.

### DETAILED DESCRIPTION OF THE EMBODIMENTS

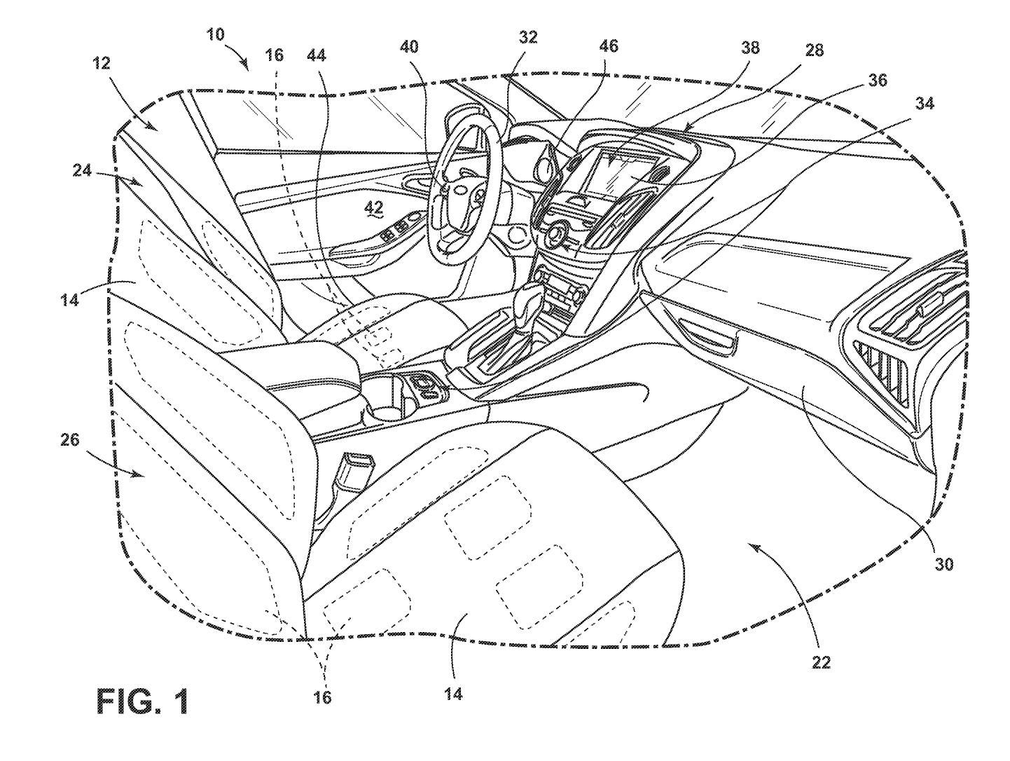

For purposes of description herein, the terms “upper,” “lower,” “right,” “left,” “rear,” “front,” “vertical,” “horizontal,” and derivatives thereof shall relate to the vehicle and its seat massage system as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to FIGS. 1-7B, reference numeral 10 generally refers to a seat massage system for a vehicle 12. The seat massage system 10 includes a vehicle seating assembly 14 having a massaging apparatus 16. A positioning device 18 determines a location of the vehicle 12. A controller 20 controls the massaging apparatus 16 based on the determined location of the vehicle 12. The vehicle 12, as shown in FIG. 1, is an automobile; however, the vehicle 12 may be a boat, airplane, or other transportation means.

As illustrated in FIG. 1, an interior 22 of the vehicle 12 includes a driver side 24 and a passenger side 26, each having the vehicle seating assembly 14 with the massaging apparatus 16. Forward from the seating assemblies 14, a center console 28 is disposed between a glove box 30 on the passenger side 26 and a steering wheel 32 on the driver side 24. The center console 28 includes a plurality of buttons 34 and a display screen 36, together referred to as an onboard user interface 38 that is arranged for use by an occupant in the seating assembly 14 on either the driver side 24 or the passenger side 26. The steering wheel 32 also includes a push button 40 for the driver to operate the onboard user interface 38. In addition, it is contemplated that other buttons to operate the onboard user interface 38 may be included on an interior door surface 42 of the vehicle 12, a side portion 44 of the seating assembly 14, or other conceivable locations on the interior 22 of the vehicle 12.

The display screen 36, as illustrated in FIG. 1, includes a touch screen feature for user interaction; however, it is contemplated that the touch screen feature may not be included on the display screen 36 and the onboard user interface 38 may be primarily operated with the plurality of buttons 34 and other inputs. The display screen 36 may also be positioned proximate an instrument cluster area 46 or other visible locations in the vehicle 12 for a seated occupant. It is also conceivable that the display screen 36 alternatively or additionally may include other display devices or visual or audio indicators of the selections and inputs of the onboard user interface 32. Further, the vehicle 12 may be alternatively arranged with one or fewer vehicle seating assemblies 14 having a massaging apparatus 16, including mid-row or rear seating locations in the vehicle 12.

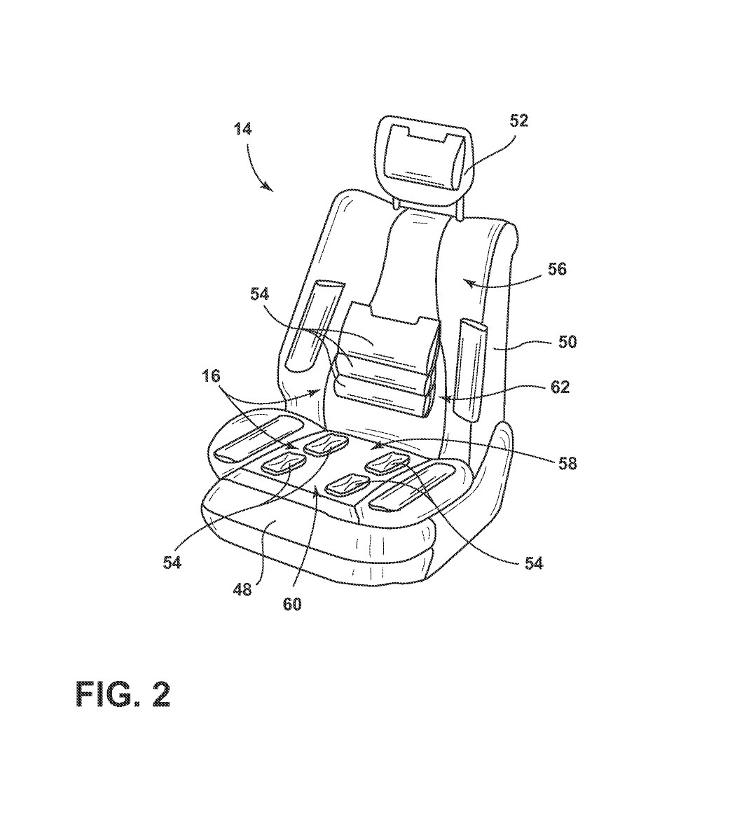

As shown in FIG. 2, the vehicle seating assembly 14 has a seat 48 pivotally coupled with a seatback 50 that extends upward to support a head restraint 52. The massaging apparatus 16 includes a plurality of seat massagers 54 positioned at various locations adjacent a support surface 56 of the seating assembly 14 to interface with a seated occupant. The seat massagers 54 each include an air bladder that is configured to be individually inflated and deflated at various rates and sequences to provide a massage to a seated occupant. As illustrated, the seat 48 includes an array of four seat massagers 54 spaced with two seat massagers 54 proximate a rear portion 58 of the seat 48 and two seat massagers 54 proximate a front portion 60 of the seat 48. The seatback 50 includes three longitudinally overlapping seat massagers 54 proximate a lumbar area 62 of the seatback 50. It is contemplated that the massaging apparatus 16 may be alternatively positioned on the seating assembly 14 and may include fewer or additional seat massagers 54. Also, it is conceivable that the seat massagers 54 may alternatively or additionally include a motor driven massage device, a thermal massage device, or other massage devices as generally understood in the art.

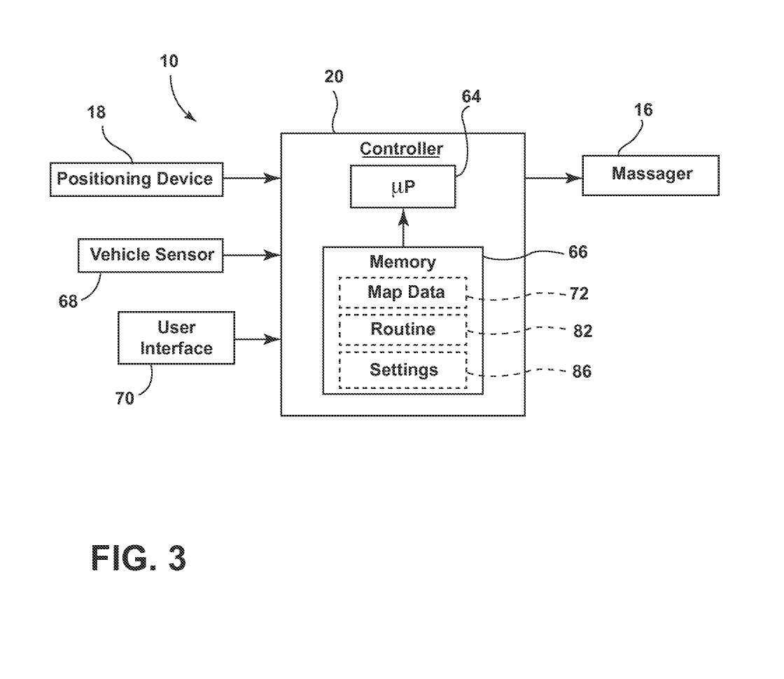

Referring now to the embodiment illustrated in FIG. 3, the controller 20 of the seat massage system 10 includes a microprocessor 64 and a memory 66. However, the controller 20 may be configured as part of a shared controller used for other purposes or configured with multiple microprocessors and memory units integrated in various locations and components as part of or separate from the vehicle 12. The memory 66 may include random access memory (RAM), read-only memory (ROM), and electrically erasable programmable read-only memory (EEPROM). As shown, the controller 20 receives inputs from various components, including the positioning device 18, a vehicle sensor 68, and a user interface 70, including the onboard user interface 38 (FIG. 1), and sends outputs to control the massaging apparatus 16, including the plurality of seat massagers 54 (FIG. 2). It is contemplated that the controller 20 may also receive inputs from additional conceivable components, such as other signals from a CAN-bus on the vehicle 12.

The positioning device 18, as shown in FIG. 3, includes a global positioning system (GPS) receiver that calculates the location of vehicle 12. The GPS receiver may be installed on the vehicle 12, integrated with other electrical components of the vehicle 12, or contained in a mobile device, such as a smartphone, tablet computer, or other portable device, that is within the vehicle 12 and is in communication with the controller 20. The positioning device 18 or controller 20 may also include a dead reckoning feature or other path navigation features to accommodate the GPS receiver in accurately calculating the location of the vehicle 12, including instances when the GPS receiver has a weak signal. It is also contemplated that the positioning device may include an additional or alternative sensor from the GPS receiver to determine the location of the vehicle.

Upon receipt of the vehicle location from the positioning device 18, the controller 20 is configured to access map data 72 from the memory 66. The map data 72 may include road information, address information, traffic information, point of interest information, and other conceivable map related information. It is contemplated that the controller 20 accesses the map data 72 or updates stored map data 72 with an internet connection, such that the traffic information, among other map related information, is current. It is also contemplated that the positioning device 18 may alternatively access the map data 72 or portions thereof. Based on the sensed vehicle location and the corresponding map data 72, the controller 20 is able to generate at least one location characteristic of the vehicle 12. The location characteristic includes a road type, a road shape, a lane position, a traffic condition, and a predicted route of travel, among other conceivable characteristics related to the environment and conditions surrounding the vehicle 12. The road type provides a general classification for the road that the vehicle 12 is traveling on, such as a city street, a country road, a highway, an interstate, and other more general or more specific road type classifications. The road shape characteristic may include a calculated value, such as turns per mile, and similarly may also include a classification of ranges of the calculated value, such as a straight road, a road with some curves, and a curvy road. It is contemplated that the location characteristics may include other more specific or more general information based on the calculated location of the vehicle 12. Further, it is conceivable that the location characteristic generated by information from the positioning device 18 may include a calculated speed of the vehicle 12.

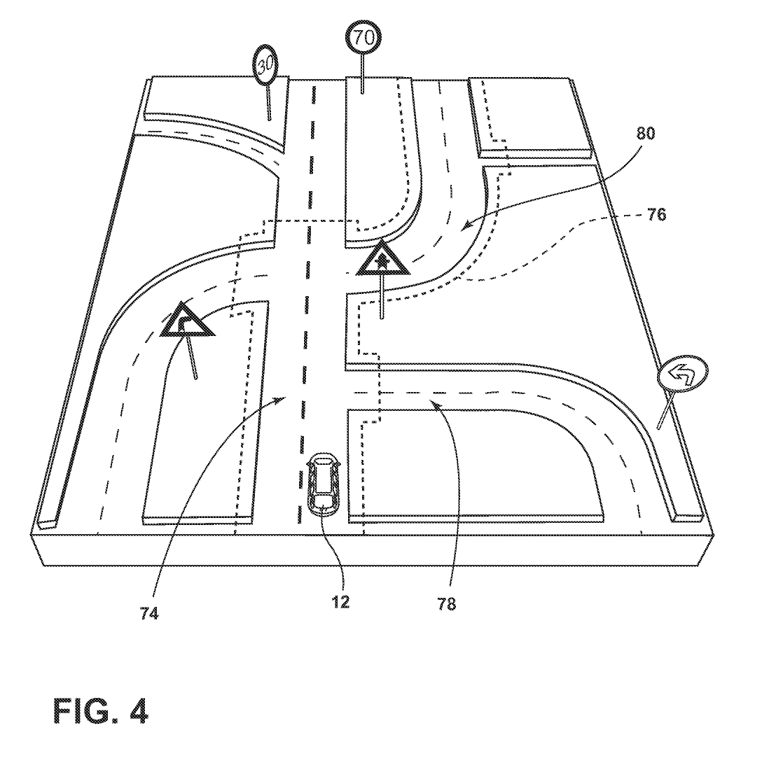

As shown in FIG. 4, a predicted route of travel 76 of the vehicle 12 generated by the controller 20 (FIG. 3) may be included as a location characteristic and may also be used by the controller 20 to determine additional location characteristics, such as the estimated time on a stretch of road, the estimated travel time, the elapsed time at a specific road type, or other conceivable location characteristics. The controller 20 may generate the predicted route of travel 76 based on a number of variables, including the reoccurring patterns of travel for the vehicle 12, a common pattern of travel for other vehicles in a similar location to the vehicle 12, and any programmed routes of travel for the vehicle 12 or for the positioning device 18. For instance, as shown in FIG. 4, the vehicle 12 is traveling on a first road 74 having a generally straight road shape characteristic. The predicted route of travel 76 calculated for the vehicle 12 indicates that the vehicle 12 will likely not turn right at a second road 78, but instead will likely turn right at a third road 80. Accordingly, the controller 20 may use the predicted route of travel 76 to alter the road shape characteristic to a curvy road. In addition, the controller 20 may calculate the estimated time before the vehicle 12 makes a turn at the third road 80 based on the vehicle location, the current speed of the vehicle 12, and any speed limit restrictions for the first road 74.

The vehicle sensor 68, as referenced in FIG. 3, may include a single vehicle sensor 68 or multiple onboard vehicle sensors 68 to independently, or jointly with another vehicle sensor 68 or the positioning device 18, sense a location characteristic of the vehicle 12. The vehicle sensors 68 may include a vehicle speed sensor, a forward facing sensor or camera, a back-up sensor or camera, a lane-keep sensor or camera, a suspension sensor, an inertia sensor, a yaw-rate sensor, and other conceivable onboard vehicle sensors 68 that may sense a location or a location characteristic of the vehicle 12, as generally understood in the art. The suspension sensor, for example, may sense vibration caused by poor road quality to determine the road type classification. Also, the forward facing, back-up, and lane-keep sensors or cameras may sense the number and speed of other vehicles surrounding the vehicle 12, for example, to determine the traffic condition. Also, the cameras may sense the number of lanes or width of the road to determine the road type classification.

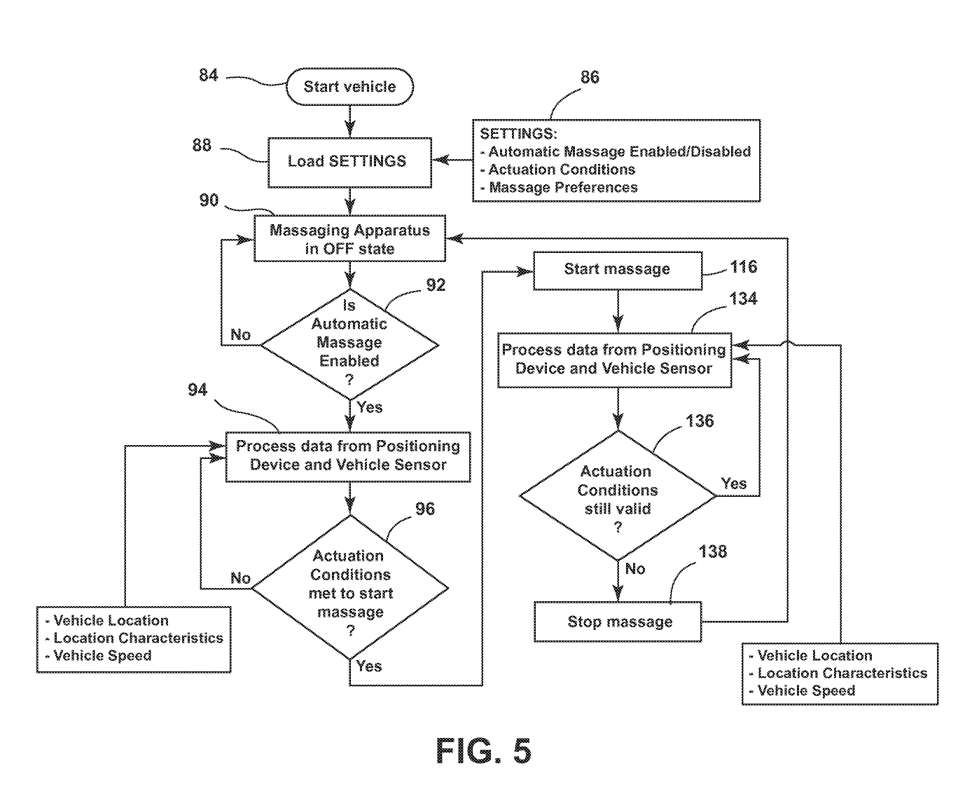

Again as reference in FIG. 3, the controller 20 controls the massaging apparatus 16 of the vehicle seating assembly 14 based on the location of the vehicle 12 and the location characteristics supplied by the positioning device 18 and the vehicle sensor 68, as described above. The controller 20 generally uses a routine 82 stored in the memory 66 to control the massaging apparatus 16. One embodiment of the routine 82 is illustrated in FIG. 5 as a flow chart diagram. As shown, at step 84 of the routine 82, the seat massage system 10 is initiated when the vehicle 12 is started, which can include starting the engine of the vehicle 12, placing the transmission of the vehicle 12 in drive, beginning a programmed route of travel, or other conceivable actions. The routine 82 then loads the settings 86 stored in the memory 66 (FIG. 3) at step 88. The settings 86 include whether an automatic massage feature is enabled or disable, a set of actuation conditions for the automatic massage feature, and a massage preference for the automatic massage feature. It is also contemplated that the settings 86 may include a default selection of the settings 86 that may then be customized as a user-defined selection of the settings 86, as described in more detail below.

As illustrated in FIG. 5, at step 90 of the routine 82, the massaging apparatus 16 is actuated to an OFF state, if not already in the OFF state, before the routine 82 determines whether the automatic massage feature is enabled. Accordingly, at step 92, the controller 20 determines from the settings 86 (FIG. 3) whether the automatic massage feature is enabled. The controller 20 will continue to monitor the settings until the automatic massage feature is enabled before proceeding to step 94 of the routine 82. Upon enabling the automatic massage feature, at step 94, the controller 20 (FIG. 3) processes data inputs that are received from the positioning device 18, the vehicle sensor 68, and other conceivable inputs. Notably, the controller 20 processes the determined vehicle location, the location characteristics of the vehicle 12, and the vehicle speed, among other location related data inputs. The controller 20 uses these inputs in conjunction with the actuation conditions of the settings 86 at step 96 to determine whether any of the actuation conditions are met by the inputs. If the actuation conditions are not met, the controller 20 continues to process and monitor the inputs, including the determined vehicle location, location characteristics, and vehicle speed received from the positioning device 18 and the vehicle sensor 68.

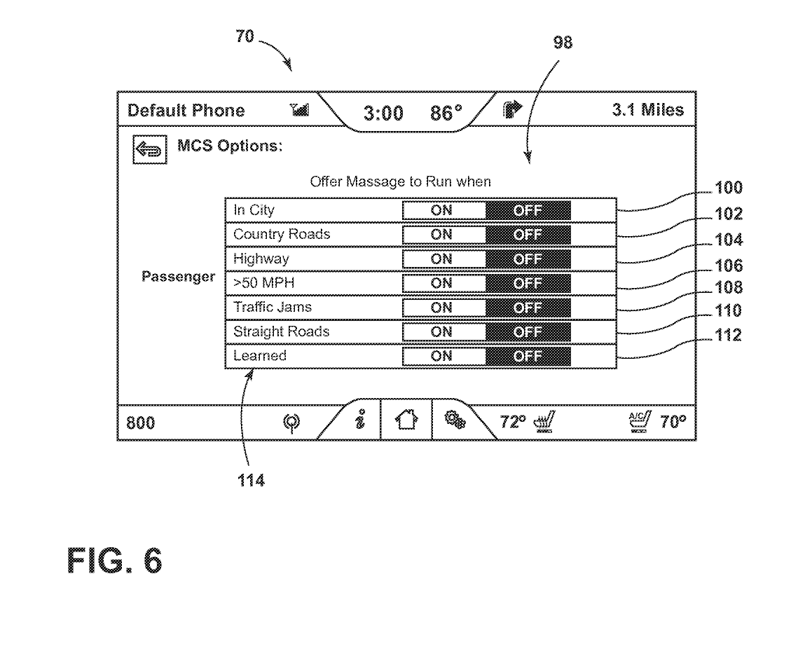

Referring now to FIG. 6, one embodiment of the user interface 70 is shown having selectable items for an occupant to choose altering the settings 86 (FIG. 3) from the default selection to the user-defined selection. More specifically, FIG. 6 shows a menu 98 of the actuation conditions in combination with an ON or OFF switch to enable to automatic massage feature for each actuation condition. The top three menu items show actuation conditions consisting of “In City” 100, “Country Roads” 102, and “Highway” 104 that correlate with the road type classification that may be sensed or determined based on the vehicle location. As stated above, it is conceivable that the road type classifications may vary from those shown in FIG. 6. The menu 98 also shows an actuation condition of “>50 MPH” 106, which monitors the vehicle speed for instances where the measured vehicle speed is greater than fifty miles per hour. However, the condition may alternatively monitor the location characteristics for the vehicle 12 traveling on roads having speed limits greater than fifty miles per hour. Another menu item is an actuation condition titled “Traffic Jams” 108, which correlates with the location characteristic derived from information from the positioning device 18 (FIG. 3) and/or the various vehicle sensors 68 (FIG. 3) that may determine when the traffic conditions surrounding the vehicle 12 are indicative of a traffic jam. For instance, the vehicle speed may be monitored for when the vehicle speed is less than 20 miles per hour under the speed limit for the road corresponding with the vehicle location for a time period longer than five minutes. Further, an actuation condition menu item titled “Straight Roads” 110 is associated with the road shape characteristic, which may be calculated based on the determined vehicle location. It is conceivable that the actuation conditions shown in FIG. 6 may be modified to stipulate when the massaging apparatus 16 is actuated or otherwise controlled, including options for the occupant to define the specific actuation condition. One example of a more specific actuation condition is a selected segment of a programmed route of travel, where the massage apparatus 16 is actuated by the controller 20 when the determined location of the vehicle 12 indicates that the vehicle 12 is traveling on the specific selected segment of the programmed route.

Still referring to FIG. 6, the bottom menu item is an actuation condition titled “Learned” 112. This actuation condition monitors a personalization system 114 that is configured to learn the behavior and preferences of the occupant associated with the specific occupant seated in the seating assembly 14. In one embodiment, the personalization system 114 is integrated with a mobile device, such as a smartphone or tablet computer, that is capable of operably coupling with the controller 20, for instance by wirelessly synchronizing over a Bluetooth connection. The personalization system 114 includes a memory, which may be the same memory 66 of the controller 20 of the seat massage system 10, for storing the current location characteristic in a data set when the massaging apparatus 16 is manually actuated. The controller 20 then monitors the data set to identify a reoccurring location characteristic in the data set. As such, the reoccurring location characteristic is used as an actuation condition when the “Learned” 112 menu item is enabled to the ON state.

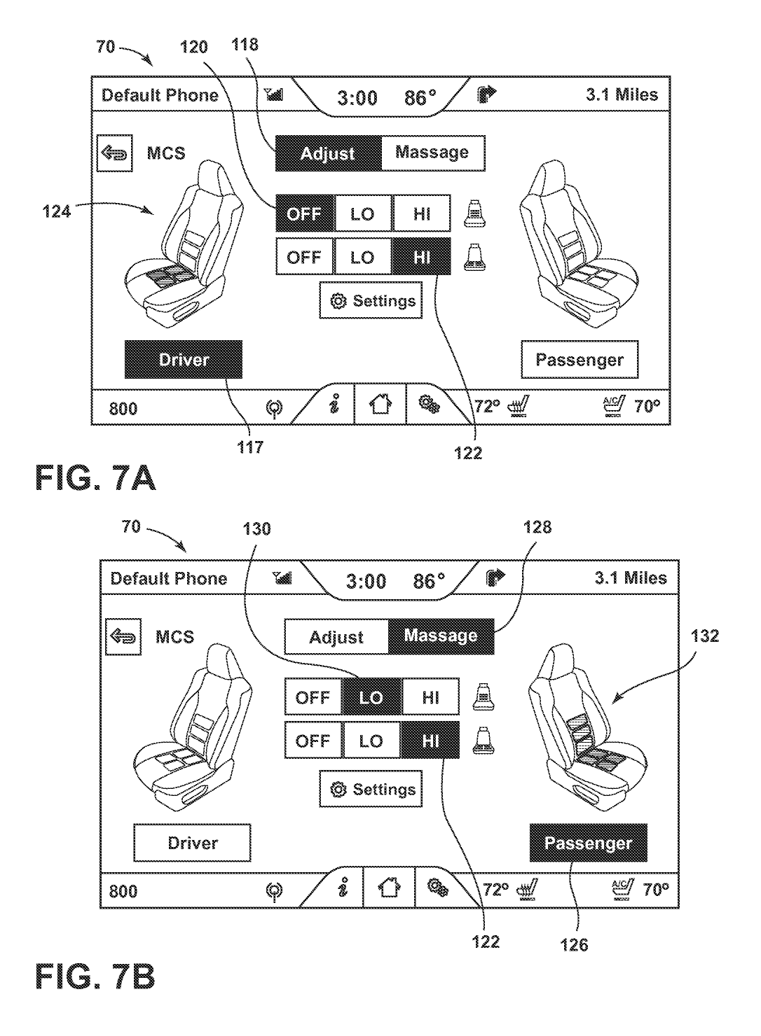

At step 116, as shown in FIG. 5, when one of the actuation conditions is met, the massaging apparatus 16 is started in accordance with the massage preferences of the settings 116. Referring now to FIGS. 7A-7B, the user interface 70 as shown on the display screen 36 (FIG. 1) is configured for an occupant to select a user-defined selection of massage preferences, altering the settings 116 from the default selection. The massage preferences, as shown in the embodiment illustrated in FIGS. 7A-7B, include coverage area of the massage and intensity level of the massage. It is contemplated that the massage preferences may include massage patterns, massage duration, and more specific coverage area and intensity levels. In addition, to further configure the settings 116, it is contemplated that the user interface 70 may include a remote user interface that may be accessed on a personal computer, a smartphone, or another device not integrated with onboard components of the vehicle 12.

As shown in FIG. 7A, the seating assembly 14 on the driver side 117 of the vehicle 12 is selected for adjustment 118 of the massage preferences of the settings 116. The seat massagers 54 (FIG. 2) on the lumbar area 62 of the seatback 50 are selected in an OFF state 120 and the seat massagers 54 (FIG. 2) on the seat 48 are selected at a high intensity level 122. In accordance with the illustrated user-defined selection of massager preferences, a left image 124 of the seating assembly 14 shows the massagers 54 on the seat 48 highlighted. Accordingly, the seat massagers 54 (FIG. 2) on the seat 48 will automatically actuate at the high intensity level 122 when an enabled actuation condition is met, as previously described. For example, when the actuation condition includes a selected continuous time on a highway road type classification, the controller 20 will actuate the massaging apparatus 16 on the seat 48 at the high intensity level 122 when the selected amount of continuous time has elapsed on a highway. It is further contemplated that the autonomous actuation of the massaging apparatus 16 may be delayed to prompt the seated occupant with a message on the user interface 70 or with an audible message that requires to seated occupant to confirm the desire for a massage before commencing with actuating the massaging apparatus 16 in accordance with the settings 86.

Referring now to FIG. 7B, the seating assembly 14 on the passenger side 126 of the vehicle 12 is selected for a manual massage 128 with the selected massage preferences. As illustrated, a right image 132 shows the seat massagers 54 (FIG. 2) on the lumbar area 62 of the seatback 50 selected at a low intensity level 130 and the seat massagers 54 on the seat 48 selected at the high intensity level 122. Further, upon initiating the manual massage 128 the controller 20 may store the location characteristic of the vehicle 12, such as traveling on a highway. Accordingly, the controller 20 may identify the highway as a reoccurring location characteristic for when the seated occupant initiates a manual massage 128. With this reoccurring location characteristic, enablement of the “Learned” 112 actuation condition will result in the seat massage system 10 monitoring for when the vehicle 12 reenters a highway to automatically actuate the massaging apparatus 16 (FIG. 2) in accordance with the identified massage preferences.

At step 134, as shown in FIG. 5, after the massaging apparatus 16 is started, the controller 20 continues to process the data from the positioning device 18 and the vehicle sensor 68 to monitor whether one of the actuation conditions is still met at step 136. When all of the actuation conditions are no longer met, the controller 20 stops the massage at step 138, ceasing the massaging apparatus 16 from providing a massage to the occupant seated in the relevant seating assembly 14. Accordingly, the seat massaging system 10 provides a system to automatically actuate and control the massaging apparatus 16 without an occupant having to manually actuate or control the massage. As such, the seat massaging system 10 will be capable of providing a massage to an occupant's pressure spots before substantial side effects from lack of muscle movement and blood flow set in, such as muscle soreness or muscle numbness in an occupant's upper legs and lower back.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A seat massage system for a vehicle comprising:
a vehicle seating assembly having a massaging apparatus;
a positioning device for determining a location of the vehicle; and
a controller for controlling the massaging apparatus based on the determined location of the vehicle.

2. The seat massage system of claim 1, wherein the controller uses map data to generate a location characteristic based on the determined location of the vehicle.

3. The seat massage system of claim 2, wherein the location characteristic includes a road type classification, and wherein the controller controls the massaging apparatus based on the road type classification.

4. The seat massage system of claim 2, wherein the positioning device accesses the map data to generate a predicted route of travel based on the determined location of the vehicle, and wherein the controller controls the massaging apparatus based on the predicted route of travel.

5. The seat massage system of claim 2, further comprising:
a user interface for selecting a massage setting, wherein the controller is operatively coupled with the user interface and the massaging apparatus, and wherein the controller controls the massaging apparatus based on the selected massage setting.

6. The seat massage system of claim 5, wherein the massage setting has an actuation condition that includes a selected continuous time on a selected road type classification, and wherein the controller actuates the massaging apparatus when the selected amount of continuous time has elapsed on the selected road type classification.

7. The seat massage system of claim 5, wherein the massage setting has a massage preference that includes a select coverage area, wherein the controller actuates the massaging apparatus with the selected massage preference.

8. A seat massage system for a vehicle comprising:
a seat massager in the vehicle;
a sensor for sensing a location characteristic of the vehicle; and
a controller for automatically actuating the seat massager based on the sensed location characteristic.

9. The seat massaging system of claim 8, further comprising:
a memory for storing the sensed location characteristic in a data set when the seat massager is manually actuated, wherein the controller identifies a reoccurring location characteristic in the data set and automatically actuates the seat massager based on when the sensed location characteristic corresponds with the reoccurring location characteristic.

10. The seat massaging system of claim 8, wherein the location characteristic of the vehicle includes a vehicle lane position, and wherein the controller controls the massaging apparatus based on the vehicle lane position.

11. The seat massaging system of claim 8, wherein the sensor includes a GPS receiver for sensing a location of the vehicle, and wherein the controller generates the location characteristic based on the sensed location of the vehicle.

12. The seat massaging system of claim 11, further comprising:
a programmed route, wherein the controller uses the programmed route to generate the location characteristic based on the location of the vehicle.

13. The seat massaging system of claim 11, wherein the controller accesses map data to determine a traffic condition based on the location of the vehicle, and wherein the controller controls the seat massager based on the traffic condition.

14. A method for controlling a vehicle seat massager comprising:
providing a seat massager in a vehicle;
determining a location of the vehicle; and
controlling the seat massager based on the determined location of the vehicle.

15. The method of claim 14, further comprising:
selecting a massage setting, wherein the seat massager is actuated based on the selected massage setting.

16. The method of claim 15, wherein the massage setting has an actuation condition that includes a selected location, and wherein the seat massager is actuated when the determined location matches the selected location.

17. The method of claim 16, wherein the massage setting has a massage preference that includes a selected intensity level for the selected location, and wherein the controller controls the seat massager at the selected intensity level based on the determined location.

18. The method of claim 14, further comprising:
accessing map data to generate a location characteristic based on the determined location of the vehicle, wherein the seat massager is controlled based on the generated location characteristic.

19. The method of claim 14, further comprising:
predicting a probable route of travel based on a travel history of the vehicle and the determined location of the vehicle, wherein the seat massager is controlled based on the probable route of travel.

20. The method of claim 19, wherein the travel history of the vehicle includes a stored location when the seat massager is manually actuated, and wherein the seat massager is automatically actuated when the determined location of the vehicle of travel corresponds with the stored location.
